(19) United States
(12) Patent Application Publication
(10) Pub. No.: US 2026/0078771 A1
(43) Pub. Date: Mar. 19, 2026

(54) AIR-SUPPLY ASSEMBLY AND BLADELESS FAN

(71) Applicant: Ningbo Singfun Electric Appliance Co., Ltd., Cixi Ningbo (CN)

(72) Inventors: Yongyuan KUANG, Cixi Ningbo (CN); Yuchu YAO, Cixi Ningbo (CN); Huabing WANG, Cixi Ningbo (CN); Chuanshun CHEN, Cixi Ningbo (CN); Youhong ZHANG, Cixi Ningbo (CN)

(73) Assignee: Ningbo Singfun Electric Appliance Co., Ltd., Cixi Ningbo (CN)

(21) Appl. No.: 19/400,066

(22) Filed: Nov. 25, 2025

(30) Foreign Application Priority Data
Oct. 30, 2025 (CN) 2025223011362

(51) Int. Cl. F04D 29/42; F04D 25/08; F04D 29/00

(52) U.S. Cl. CPC F04D 29/4226; F04D 25/08; F04D 29/002

(57) ABSTRACT

Disclosed are an air-supply assembly and a bladeless fan. The air-supply assembly includes an air-supply frame pillar and an air-supply frame. The air-supply frame pillar is provided with an air-supply frame pillar passage therein, and the air-supply frame is provided with an air-supply passage therein. The air-supply frame pillar is connected to the air-supply frame so that the air-supply frame pillar passage is in communication with the air-supply passage. An air outlet is provided on the air-supply frame.

### PRIORITIES AND CROSS REFERENCES

This Application claims priority from Chinese Application No. 2025223011362 filed on 30 Oct. 2025, the teachings of which are incorporated by reference herein in their entirety.

### TECHNICAL FIELD

The present application relates to an air-supply assembly and a bladeless fan, and is applicable to the technical field of the fan.

### BACKGROUND

The air-supply assemblies of existing bladeless fans are generally structured as a ring shape, and the air is conveyed along the entire ring structure, resulting in a longer air passage transmission distance, which causes the air-supply assembly to be noisy, with a lower air velocity, and be prone to air accumulation in the air passage. For example, Chinese patent CN201902349U discloses an electric fan structure without blades, which has: a base, a support seat and an air supply section; the support seat is connected to the base. Inside the support seat, there is a motor and fan blades installed on the output shaft of the motor. The top edge of the support seat is provided with a coupling part. The air supply section is in the shape of a circular ring frame. The inner edge of the circular ring frame is provided with an air outlet. The air supply section is coupled with the support seat through the coupling part. In the above scheme, the circular air passage of the air supply section has a long air delivery distance, and the circular way of air supply also has problems such as high noise, low air velocity, uneven air supply, and tendency to accumulate air.

### SUMMARY OF THE DISCLOSURE

The purpose of the present application is provided an air-supply assembly and a bladeless fan, aiming to solve the problems of low air velocity, high noise and uneven air supply in the existing air-supply assemblies.

The present application relates to an air-supply assembly which includes an air-supply frame pillar and an air-supply frame, an air-supply frame pillar passage is provided in the air-supply frame pillar, an air-supply passage is provided in the air-supply frame, where the air-supply frame pillar is connected to the air-supply frame so that the air-supply frame pillar passage is in communication with the air-supply passage; an air outlet is provided on the air-supply frame.

Herein, the air-supply assembly may also include an air guide component, the air guide component may be arranged at the connection portion of the air-supply frame pillar passage and the air-supply passage. An air-passage interface is provided between the air-supply frame pillar and the air-supply frame, an air-passage flared opening is formed in the air-passage interface. The air guide component may be arranged in the air-passage flared opening so that the air-passage flared opening forms an air guide passage. The air guide passage is in communication with the air-supply passage of the air-supply frame. Two sides of the air guide component may respectively form an air guide surface, and the air guide passage is formed between the air guide surface and the inner wall of the air-passage flared opening. A plurality of air outlets may be provided on the air-supply frame, which air outlets are respectively in communication with the air-supply passage. An air guide rib is provided to (around/near) each air outlet in the air-supply passage. The width of the air-supply passage may gradually reduce toward two sides thereof from the connection of the air-supply frame pillar passage and the air-supply passage. The air-supply assembly may also include an air-supply frame cover plate and an air guide cover plate, herein the air guide cover plate is arranged in the air-supply passage and forms a sealed air passage with the air-supply passage. The air-supply frame cover plate is closely arranged to the outside of the air guide cover plate. Or, the air-supply frame cover plate is integrally formed with the air guide cover plate.

The present application also provides a bladeless fan, including the air-supply assembly as described above.

Herein, the fan may include at least two air-supply assemblies. The at least two air-supply assemblies are combined to form an annular air-supply surface of the fan. The fan may also include a base assembly or a post assembly, the air-supply assembly is arranged on the base assembly or the post assembly, and the air passage of the base assembly or the post assembly is in communication with the air-supply frame pillar passage.

By connecting the air-supply frame pillar and the air-supply frame and bringing the air-supply frame pillar passage and the air-supply passage into communication, the air-supply assembly presented in the present application achieves that the air-supply frame can individually supply air through the air-supply frame pillar, thereby increasing the air velocity and reducing the noise. The air-supply assembly presented in the present application, by providing at least two air-supply assemblies to combine and form an air-supply surface, can shorten the air supply distance of a single air-supply assembly, thereby increasing the air velocity, reducing noise, and avoiding the problem of air accumulation caused by an overly long air passage. The air-supply assembly presented in the present application, by providing the air guide component in the air passages of the air-supply frame pillar and the air-supply frame, can make the air supply of the air-supply frame more uniform and reduce noise.

The bladeless fan presented in the present application, by adopting the above air-supply assembly, can effectively improve air supply efficiency and energy efficiency, thereby enhancing the experience of the product. By designing multiple air-supply assemblies to be mated and form an annular air supply structure, which has a novel and pleasant structure.

### BRIEF DESCRIPTION OF THE DRAWINGS

FIG. 1 is a front view of the fan in the present application.

FIG. 2 is a rear view of the air-supply assembly.

FIG. 3 is a magnified front view of the air-supply assembly.

FIG. 4 is a disassembled figure of the air-supply assembly.

FIG. 5 is a schematic view of the air-supply frame pillar.

FIG. 6 is a partial schematic view of the air-supply assembly, in which the air-supply frame cover plate 33 is removed.

FIG. 7 is an internal view from rear of the air-supply assembly.

FIG. 8 is an internal view of the air-supply frame.

FIG. 9 is an enlarged internal view of the air-supply frame.

FIG. 10 is a partial sectional view of the fan in the present application.

In the figures: 1. base assembly; 11. blower; 2. post assembly; 21. post air passage; 22. connection seat; 3. air-supply assembly; 31. air-supply frame pillar; 311 air-passage interface; 312. latch; 313. limit protrusion; 314. first air guide passage; 315. second air guide passage; 32. air-supply frame; 321. air outlet; 322. air guide rib; 323 air-supply passage; 33. air-supply frame cover plate; 34. air guide cover plate; 35. air guide component.

### DETAILED DESCRIPTION

To make the purposes, technical solutions and advantages of the present application clearer, the embodiments of the present application will be described in detail with the drawings below. It should be noted that, in the absence of conflict, the embodiments of the present application and the features of the embodiments may be combined arbitrarily with each other.

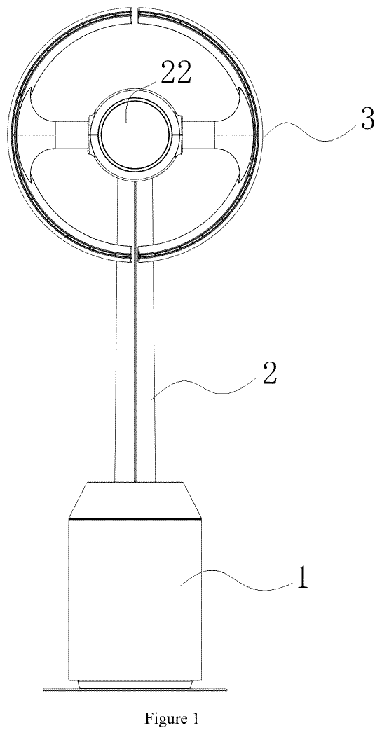

As shown in FIGS. 1-4, the present application provides an air-supply assembly, the air-supply assembly 3 includes an air-supply frame 32 and an air-supply frame pillar 31. Preferably, the air-supply frame 32 may be an integrally molded structure, which can facilitate the formation of an air-supply passage and can supply air individually. The air-supply frame pillar 31 is provided with an air-supply frame pillar passage therein, and the air-supply frame 32 is provided with an air-supply passage 323. Specifically, the air-supply frame pillar 31 is connected to the air-supply frame 32 so that the air-supply frame pillar passage is in communication with the air-supply passage 323. The air-supply frame pillar 31 and the air-supply frame 32 may be formed in one piece or formed separately. As shown in FIG. 3, an air outlet 321 is provided on the air-supply frame 32, and the air outlet 321 is in communication with the air-supply passage 323 for air blowing. Preferably, the cross-sections of the air-supply frame 32 and the air-supply passage 323 thereof are gradually narrowed sections. The air outlet 321 is located at the narrowest part of the air-supply passage 323. This design is conducive to increasing the velocity of the air supplied. By connecting the air-supply frame pillar and the air-supply frame and thus achieving the communication between the air passages thereof, the air-supply assembly presented in the present application can deliver the air individually to the air-supply frame through the air-supply frame pillar, thereby increasing the air velocity and reducing the noise.

As shown in FIGS. 1-4, in some embodiments, the air-supply assembly 3 further includes an air guide component 35. The air guide component 35 is arranged at the connection of the air-supply frame pillar passage and the air-supply passage 323, so as to guide the air to two sides of the air-supply passage 323. In the above scheme, by arranging the air guide component 35 at the connection of the air-supply frame pillar passage and the air-supply passage 323, the air in the air-supply frame pillar passage can be directed through the air guide component 35, thereby can enters two sides of the air-supply passage 323 quickly and evenly, which can improve the air supply efficiency and achieve a more balanced air supply in the air-supply passage.

As shown in FIGS. 1-5, in some embodiments, one end of the air-supply frame pillar 31 has an air-passage interface 311, and an air-passage flared opening is formed in the air-passage interface 311. The air-passage interface 311 is connected to the air-supply frame 32. Specifically, the air-passage interface 311 may be connected to the middle portion of the air-supply frame 32, the connecting type of which may be formed either separately or integrally. The air guide component 35 is arranged in the air-passage flared opening, so as to make the air-passage flared opening form an air guide passage. The air guide passage is in communication with the air-supply passage 323 for air guide. With the above scheme, the air-passage flared opening can expand the air supply space, facilitate the installation and diversion of the air guide component 35, and can expand the connection surface between the air-passage interface 311 and the air-supply frame 32, making the structure more stable.

As shown in FIGS. 3-5, in some embodiments, the cross-section of the air guide component 35 is an inverted V-shape. Two sides of the air guide component 35 respectively form an arc-shaped air guide surface, an air guide passage is formed between the arc-shaped air guide surface and the inner wall of the air-passage flared opening, and the air guide passage is in communication with the air-supply passage 323. Preferably, the air-passage flared opening is in communication with the air-supply passage 323. Specifically, the air-passage flared opening may be connected to the middle portion of the air-supply passage 323 for communicating the air passages. Specifically, the air guide passage includes a first air guide passage 314 and a second air guide passage 315, the first air guide passage 314 is in communication with one side of the air-supply passage 323, and the second air guide passage 315 is in communication with the other side of the air-supply passage 323, so that the air can be directed along two sides of the air-supply passage 323, which can make the air supply more balanced.

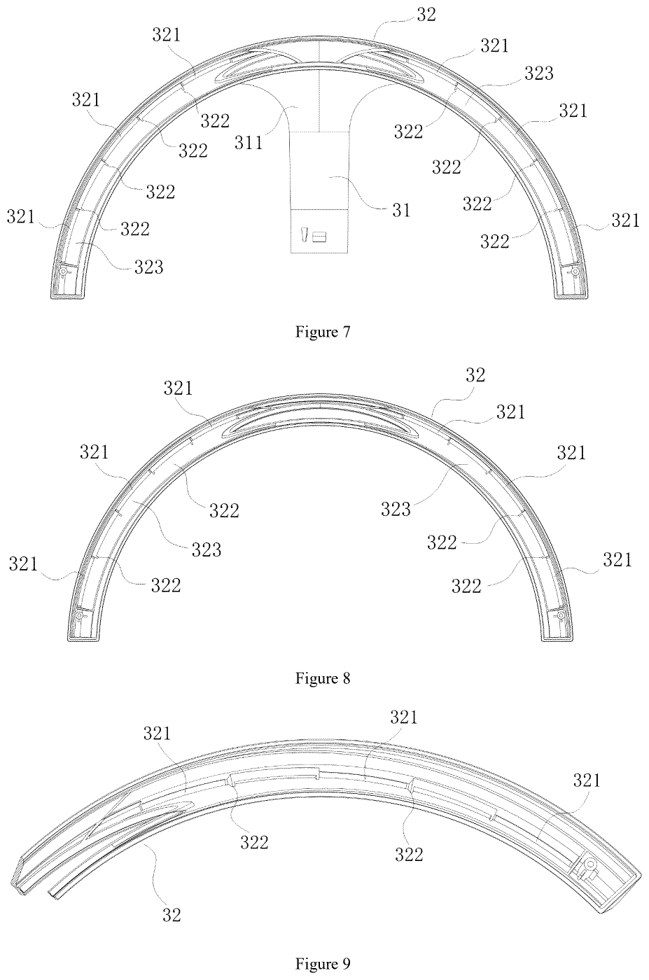

As shown in FIGS. 7-9, in some embodiments, multiple air outlets 321 are provided on the air-supply frame 32, and the air outlet 321 may be a long strip structure. Preferably, the multiple air outlets 321 are evenly distributed along the air-supply frame 32, for example, along the circumference as shown in FIG. 7, and are located on the end face of the air-supply frame 32. A plurality of air outlets 321 are respectively in communication with the air-supply passage 323. Specifically, a air guide rib 322 is provided at the position of each air outlet 321 in the air-supply passage 323, so that by providing the air guide ribs with different lengths or shapes, the air volume from the outlet can be adjusted based on the distance from the outlet to the passage interface, and the air in the air-supply passage 323 can be uniformly blown out through the air outlet 321, which can solve the problem of air accumulation in the air-supply passage.

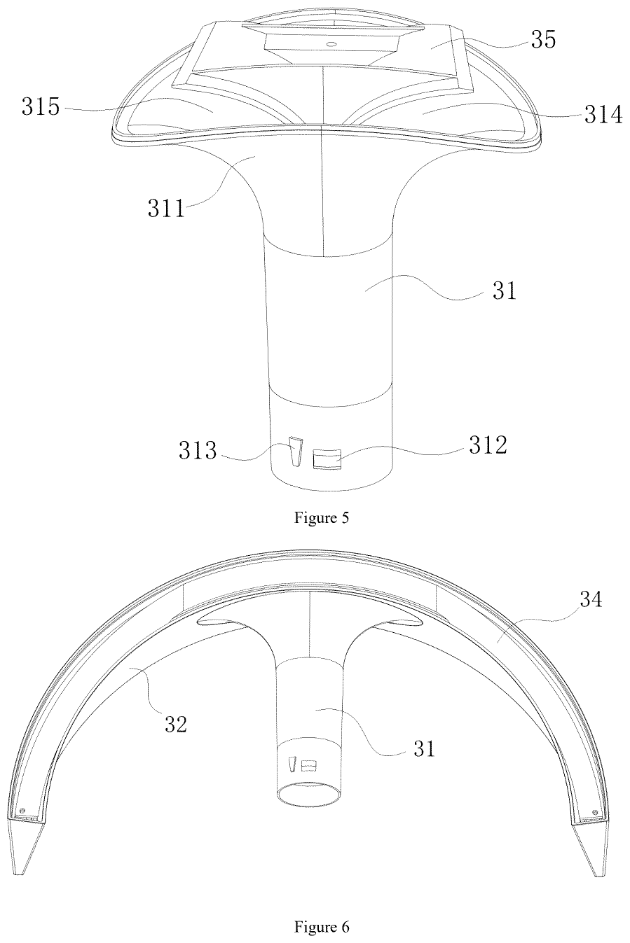

As shown in FIGS. 6-8, in some embodiments, the air-supply frame 32 is an arc-shaped structure, preferably a semi-circular structure. The air-supply frame 32 is designed as an arc-shaped structure, and the air-supply passage 323 is also an arc-shaped passage. The width of the arc-shaped passage gradually decreases toward two sides from the connection portion of the air-supply frame pillar passage and the air-supply passage 323. This design can blow out the air in the air-supply passage 323 stably and evenly from each air outlet 321 in accordance with the characteristic that the air volume passing through the air outlets successively will decrease gradually. The air-supply assembly presented in the present application, by setting the air-supply frame in an arc-shaped structure, can shorten the air-supply passage, thereby allowing the air in the air-supply passage to be discharged quickly, which can increase the air velocity, reduce the noise and avoid air accumulation due to an overly long air-supply passage.

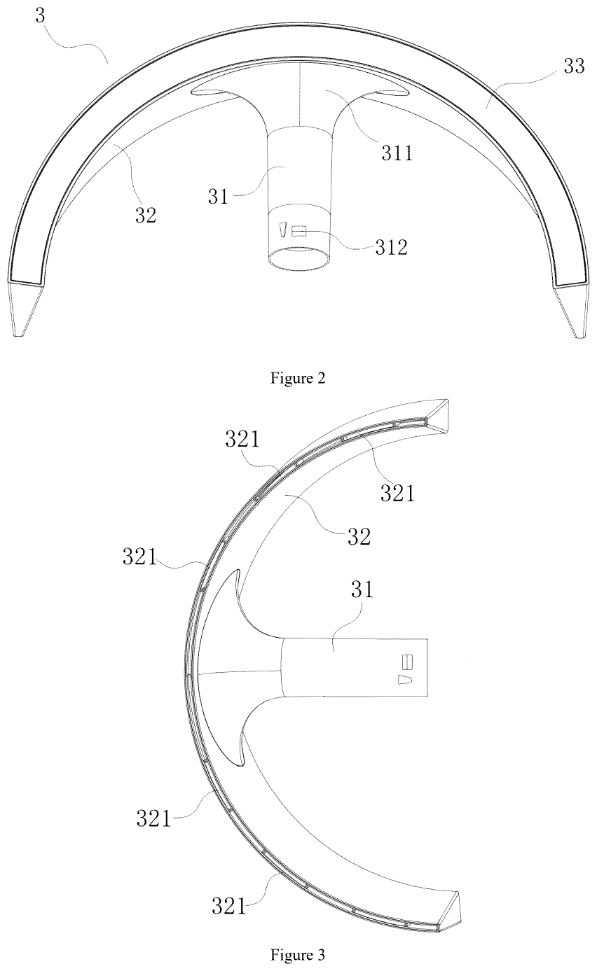

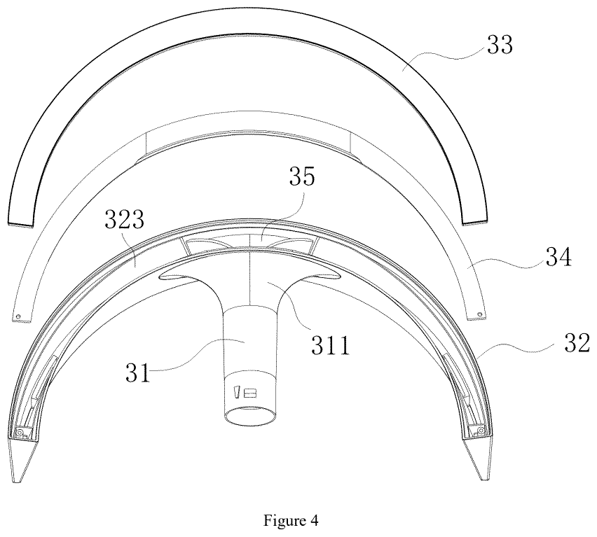

As shown in FIGS. 2-4, in some embodiments, the air-supply assembly 3 further includes an air-supply frame cover plate 33 and an air guide cover plate 34. Herein, the air guide cover plate 34 is arranged in the air-supply passage 323 and forms a sealed air passage with the air-supply passage 323, so as to enhance the efficiency of air guiding and air supplying. The air-supply frame cover plate 33 and the air guide cover plate 34 can be formed in one piece or assembled separately. In the embodiment of being assembled separately, as shown in FIG. 4, the air-supply frame cover plate 33 is arranged on the outside of the air guide cover plate 34 and covers the air guide cover plate 34, thereby providing for fully sealing, protection and decoration.

As shown in FIG. 1, the present application also provides a fan, which is a bladeless fan. Specifically, the bladeless fan includes an air-supply assembly 3, which could be the air-supply assembly as described above. The number of air-supply assembly 3 could be multiple, preferably the number is two. The two air-supply assemblies 3 are respectively connected to the connection seat 22 and form an annular air-supply assembly, which can effectively improve the air-supply efficiency and enhance the product experience. Compared to the single-strip air-supply assembly, the annular air-supply assembly can produce a more uniform and softer effect of blowing.

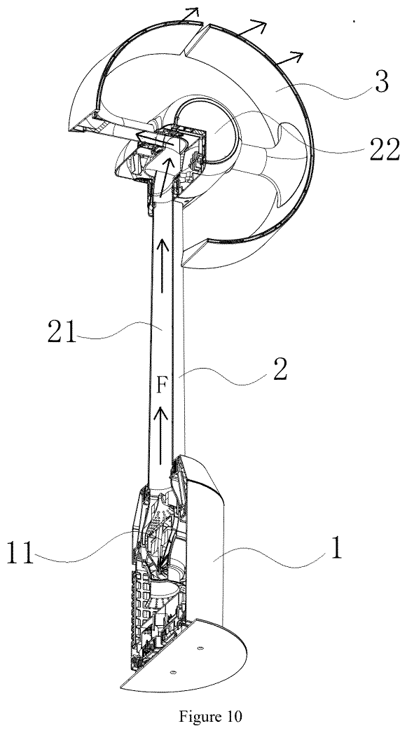

As shown in FIGS. 1 and 10, in some embodiments, the fan proposed in the present application further includes a base assembly 1 and a post assembly 2, herein the post assembly 2 is arranged on the base assembly 1. The air-supply assembly 3 is arranged on the post assembly 2, and the post air passage of the post assembly 2 is in communication with the air-supply frame pillar passage of the air-supply frame pillar 31. Further, the base assembly 1 is equipped with a blower 11 which absorbs air from the external environment by rotation and forms an airflow towards the post air passage 21, with an airflow direction referring to the F direction shown in FIG. 10.

As shown in FIGS. 1 and 10, in some embodiments, a connection seat 22 is provided on the post assembly 2, and the fan includes at least two air-supply assemblies 3. The at least two air-supply assemblies 3 are respectively connected to the connection seat 22 and combined to form the air-supply surface of the fan. Preferably, at least two air-supply assemblies 3 are combined to form an annular air-supply surface, thereby achieving an annular air supplying. Specifically, the air-supply frame pillar 31 is connected to the connection seat 22 on the post assembly 2, and thus the air-supply frame pillar passage is in communication with the air delivering passage of the connection seat 22.

As shown in FIGS. 1 and 10, in some embodiments, a primary air passage is provided in the connection seat 22. The other end of the air-supply frame pillar 31 is connected to the connection seat 22 so that the air-supply frame pillar passage is in communication with the primary air passage in the connection seat 22. Preferably, as shown in FIGS. 2 and 4, the other end of the air-supply frame pillar 31 is connected to the connection seat 22 by a snap-fit structure. Specifically, the snap-fit structure includes a latch 312 and a limit protrusion 313 respectively arranged on the air-supply frame pillar 31, and a snap and a limit slot respectively arranged on the connection seat 22. Among them, the latch 312 is compatible with the snap, enabling to be snap-fitted with each other. The limit protrusion 313 is compatible with the limit slot, enabling to be interlocked with each other. The latch 312 and the limit protrusion 313 are not limited to being arranged on the air-supply frame pillar 31, but may also be arranged on the connection seat 22. Likewise, the snap and the limit slot may also be arranged on the air-supply frame pillar 31. In addition, the latch 312 and the limit protrusion 313 do not have to be arranged on one component, but may be arranged separately, likewise, the snap and the limit slot may also be arranged separately, as long as the latch 312 and the snap can be snap-fitted with each other, and the limit protrusion 313 and the limit slot can be interlocked with each other.

Although the embodiments disclosed in the present application are described as above, the contents are only embodiments adopted for the purpose of understanding the present application and are not intended to limit the present application. Any person skilled in the art to which the application pertains may, without departing from the spirit and scope disclosed in the application, make any modifications and changes to the form and details of the application, but the scope of the patent protection of the application shall be subject to the scope defined in the appended claims.

1. An air-supply assembly, comprising:
an air-supply frame pillar, in which is provided with an air-supply frame pillar passage; and
an air-supply frame, in which is provided with an air-supply passage,
wherein, the air-supply frame pillar is connected to the air-supply frame so that the air-supply frame pillar passage is in communication with the air-supply passage, an air outlet is arranged on the air-supply frame.

2. The air-supply assembly according to claim 1, wherein, the air-supply assembly further comprises an air guide component; the air guide component is arranged at the connection of the air-supply frame pillar passage and the air-supply passage.

3. The air-supply assembly according to claim 2, wherein, an air-passage interface is provided between the air-supply frame pillar and the air-supply frame, an air-passage flared opening is formed in the air-passage interface;
the air guide component is arranged in the air-passage flared opening, so that the air-passage flared opening forms an air guide passage; the air guide passage is in communication with the air-supply passage of the air-supply frame.

4. The air-supply assembly according to claim 3, wherein, an air guide surface is formed on each of the two sides of the air guide component, the air guide passage is formed between the air guide surface and the inner wall of the air-passage flared opening.

5. The air-supply assembly according to claim 1, wherein, a plurality of air outlets which are provided on the air-supply frame are respectively in communication with the air-supply passage; an air guide rib is provided at a position of the air outlets in the air-supply passage.

6. The air-supply assembly according to claim 1, wherein, the width of the air-supply passage gradually decreases toward two sides from the connection of the air-supply frame pillar passage and the air-supply passage.

7. The air-supply assembly according to claim 1, wherein, the air-supply assembly further comprises an air-supply frame cover plate and an air guide cover plate, the air guide cover plate is arranged in the air-supply passage and forms a sealed air passage with the air-supply passage,
the air-supply frame cover plate is arranged on the outside of the air guide cover plate, or the air-supply frame cover plate is integrally formed with the air guide cover plate.

8. A bladeless fan comprising an air-supply assembly, wherein, the air-supply assembly is the air-supply assembly according to claim 1.

9. The bladeless fan according to claim 8, wherein, the fan comprises at least two air-supply assemblies, which are combined to form an annular air-supply surface of the fan.

10. The bladeless fan according to claim 8, further comprising a base assembly or a post assembly, wherein the air-supply assembly is arranged on the base assembly or the post assembly, an air passage of the base assembly or the post assembly is in communication with the air-supply frame pillar passage.

11. The bladeless fan according to claim 9, further comprising a base assembly or a post assembly, wherein the air-supply assembly is arranged on the base assembly or the post assembly, an air passage of the base assembly or the post assembly is in communication with the air-supply frame pillar passage.

12. The bladeless fan according to claim 8, wherein, the air-supply assembly further comprises an air guide component; the air guide component is arranged at the connection of the air-supply frame pillar passage and the air-supply passage.

13. The bladeless fan according to claim 12, wherein, an air-passage interface is provided between the air-supply frame pillar and the air-supply frame, an air-passage flared opening is formed in the air-passage interface;
the air guide component is arranged in the air-passage flared opening, so that the air-passage flared opening forms an air guide passage; the air guide passage is in communication with the air-supply passage of the air-supply frame.

14. The bladeless fan according to claim 13, wherein, an air guide surface is formed on each of the two sides of the air guide component, the air guide passage is formed between the air guide surface and the inner wall of the air-passage flared opening.

15. A bladeless fan comprising an air-supply assembly, wherein, the air-supply assembly is the air-supply assembly according to claim 7.

16. The bladeless fan according to claim 15, wherein, the fan comprises at least two air-supply assemblies, which are combined to form an annular air-supply surface of the fan.

17. The bladeless fan according to claim 15, further comprising a base assembly or a post assembly, wherein the air-supply assembly is arranged on the base assembly or the post assembly, an air passage of the base assembly or the post assembly is in communication with the air-supply frame pillar passage.

18. The air-supply assembly according to claim 15, wherein, the air-supply assembly further comprises an air guide component; the air guide component is arranged at the connection of the air-supply frame pillar passage and the air-supply passage.

19. The air-supply assembly according to claim 18, wherein, an air-passage interface is provided between the air-supply frame pillar and the air-supply frame, an air-passage flared opening is formed in the air-passage interface;
the air guide component is arranged in the air-passage flared opening, so that the air-passage flared opening forms an air guide passage; the air guide passage is in communication with the air-supply passage of the air-supply frame.

20. The air-supply assembly according to claim 19, wherein, an air guide surface is formed on each of the two sides of the air guide component, the air guide passage is formed between the air guide surface and the inner wall of the air-passage flared opening.
